(19) United States
(12) Patent Application Publication
(10) Pub. No.: US 2005/0167417 A1
(43) Pub. Date: Aug. 4, 2005

(54) Road finisher

(75) Inventor: Martin Buschmann, Neustadt A.d.w. (DE)

Correspondence Address: DARBY & DARBY P.C., P. O. BOX 5257, NEW YORK, NY, 10150-5257, US

(73) Assignee: Joseph Vogele AG, Mannheim (DE)

(21) Appl. No.: 11/016,324

(22) Filed: Dec. 16, 2004

(30) Foreign Application Priority Data
Jan. 19, 2004 (DE) 10 2004 002 658.0

(51) Int. Cl. H05B 3/68

(52) U.S. Cl. 219/462.1

(57) ABSTRACT

An electric heating unit for a road finisher for heating work components having at least one heating rod (1, 10) with a predetermined nominal heating power. In order to increase the reliability of operation of the heating unit and in order to facilitate heating unit repairs that have become necessary in view of a faulty heating rod (1, 10), each heating rod (1, 10) is provided with at least two heating spirals (3, 4; 12, 13, 14) each provided with an electric lead (6, 7; 16, 17, 18) of its own, both of the leads being connected to a user-accessible connection means (8).

The invention relates to a road finisher provided with an electric heating unit for heating work components.

Road finishers are provided with a heating unit which heats a great variety of work components that come into contact with the heated paving material for producing road surfaces, so as to avoid, on the one hand, premature cooling of said paving material and so to prevent, on the other hand, the paving material from solidifying on and adhering to the cold surfaces of the respective work component. These heating units normally contain heating rods which must be arranged directly on the component to be heated. Not all the locations at which a heating rod must be mounted are, of course, easily accessible from outside. In many cases, it is necessary to switch off the road finisher completely and to let it cool down over night before a heating rod is accessible. This makes it more much difficult to replace and demount faulty heating rods.

It is therefore the object of the present invention to provide a road finisher with an electric heating unit in the case of which defects of the heating unit can be compensated more easily.

This object is achieved by a road finisher provided with an electric heating unit used for heating work components and comprising at least one heating rod which has a predetermined nominal heating power, the heating rod comprising at least two heating spirals each provided with an electric lead of its own, said leads being connected to a user-accessible connection means.

Due to the structural design according to the present invention, the repair location in the case of a defect of the heating unit is transferred to a point which is accessible to the user so that the heating unit can be repaired, if necessary while the road finisher is still in operation, by simple reconnection or switching over.

The above object is additionally achieved by a road finisher provided with an electric heating unit used for heating work components and comprising at least one heating rod which has a predetermined nominal heating power, the heating rod comprising a number of heating spirals which are activated and the power of each individual one of which corresponds to the nominal heating power divided by n, each heating spiral being connected to a connection means.

On the basis of the embodiment according to the present invention, heating rod repairs or an exchange of the heating rod can be postponed until the road finisher is switched off anyhow, e.g. when the work in question has been finished, or until thorough servicing is due. Nevertheless, the use of the heating rod can be continued, though with reduced power, even if a heating spiral fails to operate.

Advantageous further developments of the present invention are disclosed in the subclaims.

In the following, embodiments of the present invention will be explained in detail making reference to the drawings, in which:

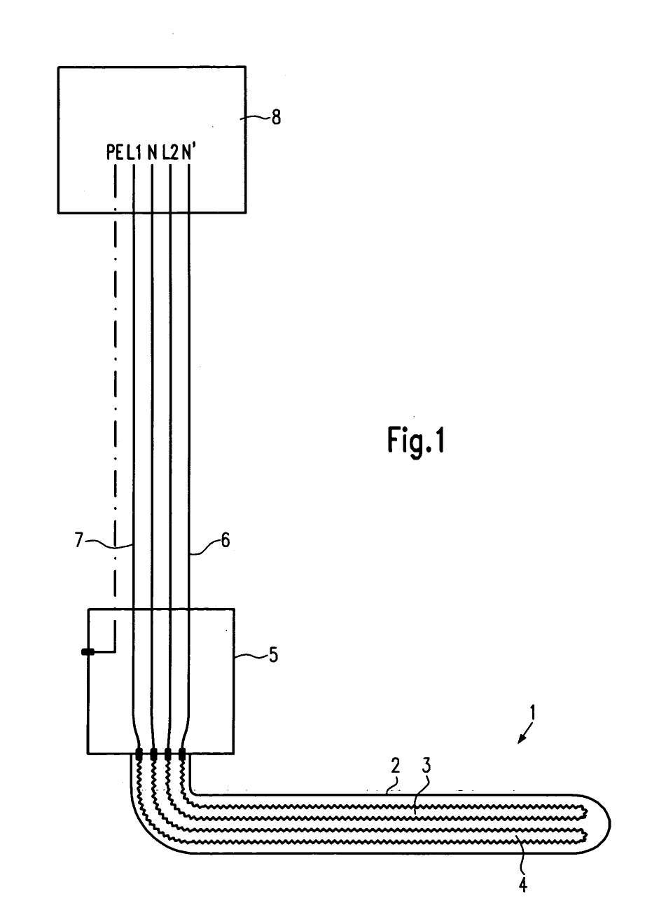

FIG. 1 shows a first embodiment of a heating rod according to the present invention for use in a road finisher, and

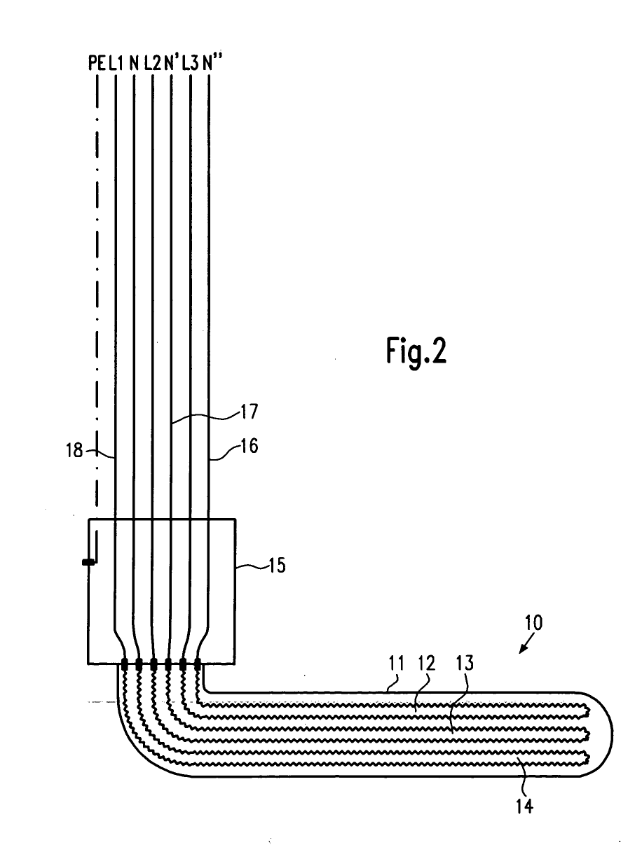

FIG. 2 shows a schematic representation of a further embodiment of a heating rod according to the present invention for use in a road finisher.

FIG. 1 shows in a schematic representation a first embodiment of a heating rod 1 for a heating unit of a road finisher. The heating rod 1 can be used for a great variety of heating purposes, but it is preferably used for heating the paving screed. In the embodiment shown, the heating rod 1 is a flat heating element and comprises a housing 2 which accommodates more than the usual number of heating spirals, in the present embodiment two heating spirals 3 and 4. Each of said heating spirals 3, 4 is rated for the total, predetermined nominal heating power required for the heating rod 1. It follows that, if only one of the heating spirals 3 or 4 is in operation, the heating rod 1 will provide the full heating power. Each heating spiral 3, 4 is provided with a separate lead 6 and 7, respectively, via an electric connection 5, the respective heating spirals 3, 4 being supplied with power via said leads 6, 7. The leads 6 and 7, respectively, comprise one cable with two circuits or two separate cables with one circuit each The leads 6, 7 of all heating spirals 2, 3 lead to a user-accessible connection means 8, which is e.g. the usual terminal box on a paving screed of the road finisher. Other connection means, which may perhaps be specially reserved for the heating unit, can be provided. In addition, it is also possible to implement the connection means 8 such that the leads 6, 7 cannot be clamped thereto, but to connect said leads 6, 7 via a switch to the power supply.

During normal operation, only one of the heating spirals 3 or 4 has power supplied thereto and provides the full heating power which is required for the heating unit. The other heating spiral is separated from the power supply, e.g. by a suitably set switch or by disconnection. If the heating spiral activated at the time in question fails, it will only be necessary to reconnect the leads, or to operate the switch in question, so as to activate the other heating spiral which will then again provide the full heating power.

Deviating from the representation according to FIG. 1, the housing 2 of the heating rod 1 may also accommodate more than two heating spirals. Also in this case, all the heating spirals can be rated for the demanded nominal heating power of the heating rod, and only one heating spiral can be activated, but it is also possible to implement the heating spirals such that the nominal heating power is divided by the number n of heating spirals to be accommodated and that each of said heating spirals contributes only this part, i.e. the nth part, to the total nominal power of the heating rod, the full number of heating spirals being, however, activated. If one of the heating spirals now fails to operate, the total power of the heating rod 1 will only decrease to an insignificant extent so that it will be possible to operate the heating rod with reduced power for a certain period of time, until the faulty heating spiral will have to be replaced.

As can be seen from FIG. 2, it is in the case of this embodiment not absolutely necessary to implement the connection means such that it is accessible to the user directly and immediately.

FIG. 2 shows such an embodiment of a heating rod 10 in which three heating spirals 12, 13, and 14 are accommodated in a conventional housing 11. Each of said heating spirals 12, 13, 14 is supplied with power via an electric connection 15 and, if desired, again via a respective separate lead 16, 17 and 18, said leads being, however, connected to the electric power supply in the usual way. Each of the heating spirals 12, 13, 14 has a heating power corresponding to one third of the nominal heating power of the heating rod 10, i.e., if one of the heating spirals fails to operate, the heating rod 10 can nevertheless be operated with two thirds of the nominal heating power, and this will in most cases suffice until the next thorough servicing of the road finisher is due.

As a modification of the embodiment described and shown hereinbefore, the number of heating spirals can be increased in the case of both embodiments. Instead of being used in connection with flat heating elements, the invention can also be used for other heating units.

1. An electric heating unit for a road finisher used for heating work components and comprising:
at least one heating rod which has a predetermined nominal heating power having at least two heating spirals each provided with an electric lead of its own, said leads being connected to a user-accessible connection means.

2. An electric heating unit according to claim 1, wherein the heating power of each of said heating spirals corresponds to the nominal heating power and wherein only one heating spiral at a time is activated.

3. An electric heating unit according to claim 1, having a number n of heating spirals that are activated, the power of each individual heating spiral corresponding to the nominal power divided by n.

4. An electric heating unit according to claim 1, wherein the leads are clamped to a distributor of the connection means.

5. An electric heating unit according to claim 1, wherein the leads of the heating spirals of a heating rod are interconnected via a switch of said connection means.

6. An electric heating unit according to claim 1, wherein the heating rod comprises a a flat heating element.

7. An electric heating unit for a road finisher used for heating work components and comprising:
at least one heating rod which has a predetermined nominal heating power, the heating rod comprising a number of heating spirals which are activated and the power of each individual one of which corresponds to the nominal heating power divided by n, each heating spiral being connected to a connection means.

8. A heating rod for a heating unit of a road finisher according to claim 1 having a plurality of heating spirals each having an electric lead of its own.
